(19) United States
(12) Patent Application Publication
(10) Pub. No.: US 2006/0278758 A1
(43) Pub. Date: Dec. 14, 2006

(54) Secondary arresting line release mechanism

(75) Inventor: Gary Bryan Landsberg, Stewartstown, PA (US)

Correspondence Address: VENABLE LLP, P.O. BOX 34385, WASHINGTON, DC, 20043-9998, US

(73) Assignee: AAI Corporation, Hunt Valley, MD (US)

(21) Appl. No.: 11/376,762

(22) Filed: Mar. 16, 2006

Related U.S. Application Data
(60) Provisional application No. 60/662,816, filed on Mar. 18, 2005.

(51) Int. Cl. B64F 1/02

(52) U.S. Cl. 244/110 C

(57) ABSTRACT

A vehicle motion arresting mechanism for arresting the motion of a vehicle is provided. The mechanism includes a pendant for engaging an engagement member of the vehicle; a first tension limiting member attached to a first end of the pendant, the first tension limiting member having a first shear pin; a second tension limiting member attached to a second end of the pendant, the second tension limiting member having a second shear pin; a tension adjusting member attached to the first tension limiting member and for adjusting an at-rest tension of the pendant; a first anchoring member for anchoring the tension adjusting member to the ground; and a second anchoring member for anchoring the second tension limiting member to the ground. The first and second shear pins are adapted to break when the pendant experiences a predetermined tension, the breaking of the first shear pin allowing the pendant to separate from the tension adjusting member, and the breaking of the second shear pin allowing the pendant to separate from the second anchoring member.

This application claims the benefit of U.S. Provisional Patent Application No. 60/662,816 filed Mar. 18, 2005, which is hereby incorporated by reference in its entirety.

This invention was made with Government support under DAAH01-03-G-0004 awarded by the U.S. Army and Missile Command. The Government has certain rights in this invention.

### BACKGROUND OF THE INVENTION

The invention relates to vehicle arresting systems. More particularly, the invention relates to air vehicle arresting systems using a line or cable.

### SUMMARY OF THE INVENTION

An embodiment of the invention provides a vehicle motion arresting mechanism for arresting the motion of a vehicle. The mechanism includes a pendant for engaging an engagement member of the vehicle; a first tension limiting member attached to a first end of the pendant, the first tension limiting member having a first shear pin; a second tension limiting member attached to a second end of the pendant, the second tension limiting member having a second shear pin; a tension adjusting member attached to the first tension limiting member and for adjusting an at-rest tension of the pendant; a first anchoring member for anchoring the tension adjusting member to the ground; and a second anchoring member for anchoring the second tension limiting member to the ground. The first and second shear pins are adapted to break when the pendant experiences a predetermined tension, the breaking of the first shear pin allowing the pendant to separate from the tension adjusting member, and the breaking of the second shear pin allowing the pendant to separate from the second anchoring member.

The invention also provides a vehicle motion arresting system for arresting the motion of a vehicle. The system includes a primary pendant for engaging an engagement member of the vehicle; a secondary pendant for engaging the engagement member of the vehicle, a first end of the secondary pendant being coupled to the primary pendant by a first coupler and the second end of the secondary pendant being coupled to the primary pendant by a second coupler; a first tension limiting member attached to a first end of the secondary pendant, the first tension limiting member having a first shear pin; a second tension limiting member attached to a second end of the secondary pendant, the second tension limiting member having a second shear pin; a tension adjusting member attached to the first tension limiting member and for adjusting an at-rest tension of the secondary pendant; a first anchoring member for anchoring the tension adjusting member to the ground; and a second anchoring member for anchoring the second tension limiting member to the ground. The first and second shear pins are adapted to break when the secondary pendant experiences a predetermined tension, the breaking of the first shear pin allowing the secondary pendant to separate from the tension adjusting member, and the breaking of the second shear pin allowing the secondary pendant to separate from the second anchoring member.

### BRIEF DESCRIPTION OF THE DRAWINGS

Further advantages and details of the invention follow from the exemplary embodiments and are explained in the following with the aid of the Figures, in which:

FIG. 1 is a plan view of an embodiment of the invention;

FIG. 2 is a perspective view of an example of a tension limiting member in accordance with the invention; and

FIG. 3 is a plan view of a second embodiment of the invention.

### DETAILED DESCRIPTION OF THE INVENTION

The invention will be described using the example of an arresting mechanism for catching and decelerating a landing air vehicle, particularly an unmanned air vehicle. Although the invention will be described using this example, it is noted that the invention can be used to catch and decelerate other vehicles such as, for example, land vehicles.

Arresting mechanisms using a line to catch, for example, a tail hook of an air vehicle are known. The invention improves upon previously known arresting line mechanisms by providing a release mechanism that has repeatable pendant tension and is relatively insensitive to alignment with a primary arresting line.

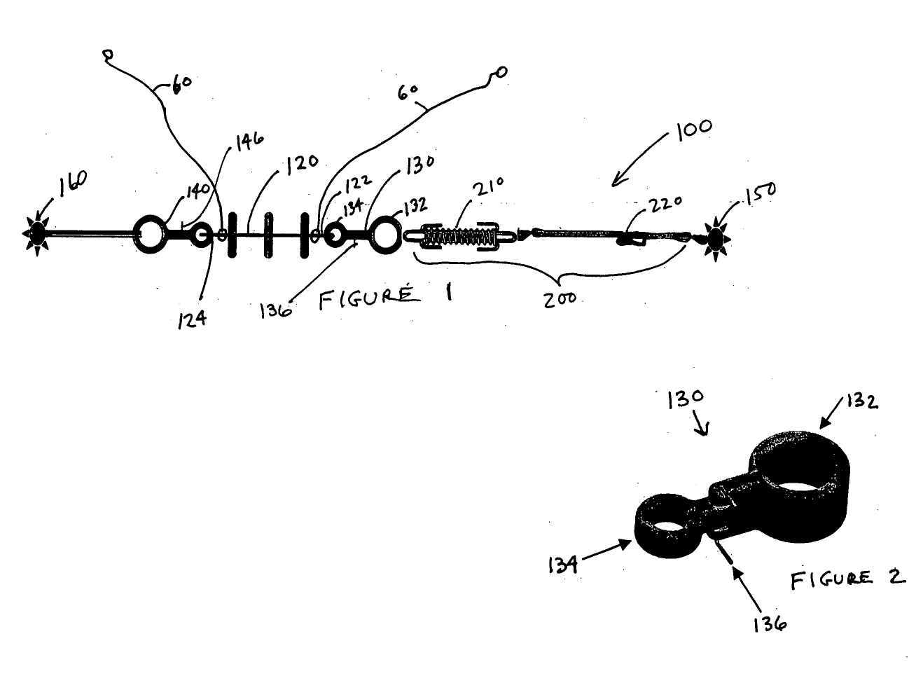

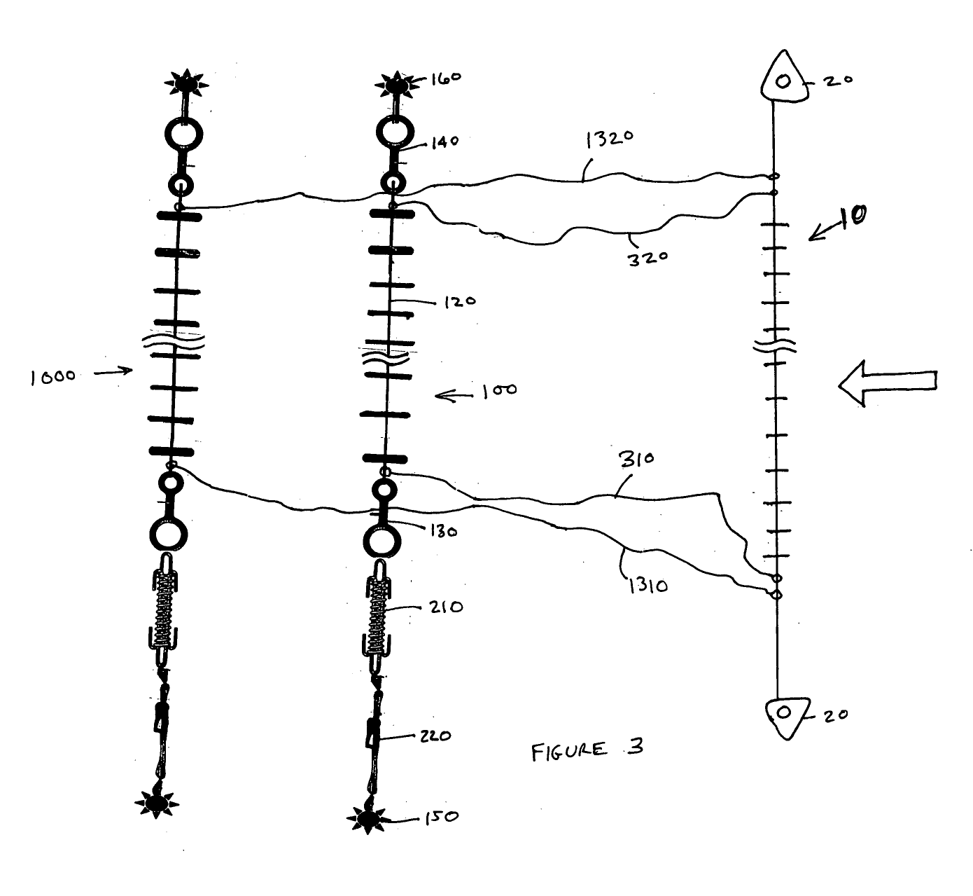

FIG. 1 shows an example of a vehicle motion arresting mechanism 100 in accordance with the invention. This example can be used by itself or as a secondary vehicle motion arresting mechanism that is a part of a larger vehicle motion arresting system, as shown in FIG. 3. Referring back to FIG. 1, vehicle motion arresting mechanism 100 has a pendant 120 which, in this example, is a cable for snaring the tail hook of an unmanned air vehicle upon landing. It is noted that pendant 120 is shown shorter than its actual size in FIG. 1 for clarity purposes. In actuality, pendant 120 makes up a much higher percentage of the entire length of vehicle motion arresting mechanism 100. Pendant 120 is attached at its first end 122 to a first tension limiting member 130 and at its second end 124 to a second tension limiting member 140. Second tension limiting member 140 is, in turn, attached to a second anchoring member 160 that is fixed to a stationary object such as, for example, the ground or a heavy piece of equipment. First tensioning limiting member 130 is attached to a tension adjusting member 200 which is, in turn, connected to a first anchoring member 150 that is fixed to a stationary object such as, for example, the ground or a heavy piece of equipment. Pendant 120 is connected to the ground or another fixed object by coupling members 60.

In this example, tension adjusting member 200 includes a tension spring gauge 210 and an adjustable length member 220. Adjustable length member 220 can be, for example, a ratcheting strap.

In use, first anchoring member 150 and second anchoring member 160 are fixed to stationary objects and the length of adjustable length member 220 is adjusted so that pendant 120 is under a predetermined tension. Tension spring gauge 210, by its length or other indicating means, can indicate the tension applied to pendant 120.

First tension limiting member 130 (and, similarly, second tension limiting member 140) is constructed such that its end attached to pendant 120 and its end that is ultimately attached to one of the anchoring members separate from each other when subjected to a break tension. FIG. 2 shows an example of first tension limiting member 130 having a first sheer pin 136 connecting a first end 132 and a second end 134. When pendant 120 is subjected to a tension equal to or greater than the break tension, first sheer pin 136 is sheared and first end 132 is permitted to separate from second end 134. For reuse, first end 132 and second end 134 are aligned with each other and a new first sheer pin 136 is installed to ready the first tension limiting member for a subsequent use. It is noted that other replaceable tension limiting means other than sheer pins can be used. In this example, second tension limiting member 140 is of similar construction to first tension limiting member 130.

FIG. 3 shows a vehicle motion arresting system using one vehicle motion arresting mechanism 100 as a secondary vehicle motion arresting mechanism and a second vehicle motion arresting mechanism as a tertiary vehicle motion arresting mechanism attached to a primary vehicle motion arresting mechanism 10. In such a system, the primary vehicle motion arresting mechanism 10 is a cable or rope tensioned between two tensioners 20 for catching the tail hook of an unmanned air vehicle. Secondary vehicle motion arresting mechanism 100 and tertiary vehicle motion arresting mechanism 1000 (and additional vehicle motion arresting mechanisms, if desired) provide additional cables with which to snag an unmanned air vehicle if the vehicle fails to snag primary vehicle motion arresting mechanism 10.

FIG. 3 shows that secondary vehicle motion arresting mechanism 100 is attached to primary vehicle motion arresting mechanism 10 by a first coupling member 310 and a second coupling member 320. Similarly, tertiary vehicle motion arresting mechanism 1000 is attached to primary vehicle motion arresting mechanism 10 by a first coupling member 1310 and a second coupling member 1320.

A landing unmanned air vehicle that fails to snag primary vehicle motion arresting mechanism 10 but successfully snags pendant 120 of secondary vehicle motion arresting mechanism 100 will be decelerated as the springs of tension spring gauge 210 compress. If during this deceleration pendant 120 is subjected to a tension greater than the break tension of first and second tension limiting members 130, 140, first and second sheer pins 136, 146 will sheer and pendant 120 will break free from first and second anchoring members 150, 160. However, because pendant 120 is connected to primary vehicle motion arresting mechanism 10 by first coupling member 310 and second coupling member 320, the unmanned air vehicle will continue to be decelerated by primary vehicle motion arresting mechanism 10 after the slack in first coupling member 310 and second coupling member 320 is taken up. Tertiary (and any subsequent) motion arresting mechanism 1000 operates similar to secondary vehicle motion arresting mechanism 100.

The invention is not limited to the above-described exemplary embodiments. It will be apparent, based on this disclosure, to one of ordinary skill in the art that many changes and modifications can be made to the invention without departing from the spirit and scope thereof.

What is claimed is:

1. A vehicle motion arresting mechanism for arresting the motion of a vehicle, the mechanism comprising:
a pendant for engaging an engagement member of the vehicle;
a first tension limiting member attached to a first end of the pendant, the first tension limiting member having a first shear pin;
a second tension limiting member attached to a second end of the pendant, the second tension limiting member having a second shear pin;
a tension adjusting member attached to the first tension limiting member and for adjusting an at-rest tension of the pendant;
a first anchoring member for anchoring the tension adjusting member to the ground; and
a second anchoring member for anchoring the second tension limiting member to the ground,
wherein the first and second shear pins are adapted to break when the pendant experiences a predetermined tension, the breaking of the first shear pin allowing the pendant to separate from the tension adjusting member, and the breaking of the second shear pin allowing the pendant to separate from the second anchoring member.

2. The mechanism of claim 1, wherein the tension adjusting member comprises a tension spring gauge and an adjustable length member, the length of the adjustable length member being adjustable to set the at-rest tension of the pendant.

3. The mechanism of claim 2, wherein the adjustable length member is a ratcheting strap.

4. The mechanism of claim 3, further comprising a fixed length flexible member having a first end and a second end, the first end being attached to the second anchoring member and the second end being attached to the second tension limiting member.

5. The mechanism of claim 4, wherein the first tension limiting member is adapted to receive a new first shear pin to enable the mechanism to be reused, and the second tension limiting member is adapted to receive a new second shear pin to enable the mechanism to be reused.

6. The mechanism of claim 2, further comprising a fixed length flexible member having a first end and a second end, the first end being attached to the second anchoring member and the second end being attached to the second tension limiting member.

7. The mechanism of claim 6, wherein the first tension limiting member is adapted to receive a new first shear pin to enable the mechanism to be reused, and the second tension limiting member is adapted to receive a new second shear pin to enable the mechanism to be reused.

8. The mechanism of claim 7, where in the mechanism is adapted to be a secondary motion arresting mechanism for coupling to a primary vehicle motion arresting mechanism, the secondary motion arresting mechanism further comprising
a first coupling member that is attached to the first end of the pendant of the secondary motion arresting mechanism and is for attaching to a pendant of the primary vehicle motion arresting mechanism, and
a second coupling member that is attached to the second end of the pendant of the secondary motion arresting mechanism and is for attaching to the pendant of the primary vehicle motion arresting mechanism.

9. The mechanism of claim 8, wherein the pendant of the secondary motion arresting mechanism is adapted to engage an engagement member of an air vehicle.

10. The mechanism of claim 7, wherein the pendant is adapted to engage an engagement member of an air vehicle.

11. A vehicle motion arresting system for arresting the motion of a vehicle, the system comprising:
a primary pendant for engaging an engagement member of the vehicle;
a secondary pendant for engaging the engagement member of the vehicle, a first end of the secondary pendant being coupled to the primary pendant by a first coupler and the second end of the secondary pendant being coupled to the primary pendant by a second coupler;
a first tension limiting member attached to a first end of the secondary pendant, the first tension limiting member having a first shear pin;
a second tension limiting member attached to a second end of the secondary pendant, the second tension limiting member having a second shear pin;
a tension adjusting member attached to the first tension limiting member and for adjusting an at-rest tension of the secondary pendant;
a first anchoring member for anchoring the tension adjusting member to the ground; and
a second anchoring member for anchoring the second tension limiting member to the ground,
wherein the first and second shear pins are adapted to break when the secondary pendant experiences a predetermined tension, the breaking of the first shear pin allowing the secondary pendant to separate from the tension adjusting member, and the breaking of the second shear pin allowing the secondary pendant to separate from the second anchoring member.

12. The system of claim 11, wherein the tension adjusting member comprises a tension spring gauge and an adjustable length member, the length of the adjustable length member being adjustable to set the at-rest tension of the secondary pendant.

13. The system of claim 12, wherein the adjustable length member is a ratcheting strap.

14. The system of claim 13, further comprising a fixed length flexible member having a first end and a second end, the first end being attached to the second anchoring member and the second end being attached to the second tension limiting member.

15. The system of claim 14, wherein the first tension limiting member is adapted to receive a new first shear pin to enable the system to be reused, and the second tension limiting member is adapted to receive a new second shear pin to enable the system to be reused.

16. The system of claim 12, further comprising a fixed length flexible member having a first end and a second end, the first end being attached to the second anchoring member and the second end being attached to the second tension limiting member.

17. The system of claim 16, wherein the first tension limiting member is adapted to receive a new first shear pin to enable the system to be reused, and the second tension limiting member is adapted to receive a new second shear pin to enable the system to be reused.

18. The system of claim 17, wherein the pendant of the secondary motion arresting mechanism is adapted to engage an engagement member of an air vehicle.

19. The system of claim 11, wherein the pendant of the secondary motion arresting mechanism is adapted to engage an engagement member of an air vehicle.
